(19) United States
(12) Patent Application Publication
(10) Pub. No.: US 2020/0017022 A1
(43) Pub. Date: Jan. 16, 2020

(54) SIGNALING DEVICE FOR THE IDENTIFICATION OF AN AUTONOMOUS VEHICLE BY A PERSON WHO IS WAITING FOR IT

(71) Applicant: PSA Automobiles SA, Poissy (FR)

(72) Inventors: Jean Luc POGNON, PUTEAUX (FR); Franck BREVET, LE CHESNAY (FR); Saran DIAKITE KABA, VITRY SUR SEINE (FR); Sandrine DELENNE, PALAISEAU (FR); Virgile CHARTON, PARIS (FR)

(21) Appl. No.: 16/471,514

(22) PCT Filed: Jan. 10, 2018
(86) PCT No.: PCT/FR2018/050051

§ 371 Date: Jun. 19, 2019

(30) Foreign Application Priority Data
Jan. 19, 2017 (FR) 1750398

(51) Int. Cl. B60Q 1/50; G08G 1/00; B60Q 5/00; B60Q 3/80; B60Q 3/70; H04W 4/12

(52) U.S. Cl. CPC B60Q 1/50; G08G 1/207; H04W 4/12; B60Q 3/80; B60Q 3/70; B60Q 5/005

(57) ABSTRACT

A signaling device (DS) equips an autonomously-dri-ving vehicle (VA) and comprising location means (ML) able to deter-mine its ongoing position, lighting means (MEI-ME2) able to generate luminous signals and exterior warning means (MAE) able to generate sounds. This signaling device (DS) comprises processing means (MT) able, when the vehicle (VA) has to meet a person (PA) at a place (EC) having a known position, to trigger a predefined signaling of the vehi-cle (VA) by the lighting means (ME I-ME2) and/or the exterior warning means (MAE), as soon as the difference between the ongoing position of the vehicle (VA) and the known position of the place is less than a threshold.

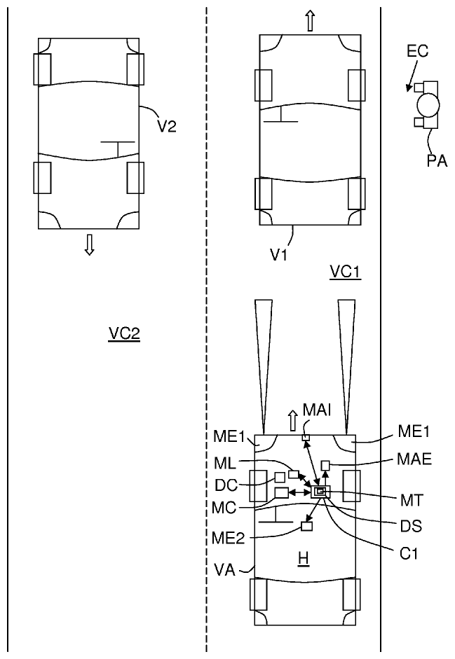

### CROSS-REFERENCE TO RELATED APPLICATIONS

This application is the US National Stage under 35 USC § 371 of International Application No. PCT/FR2018/050051, filed 10 Jan. 2018 which claims priority to French Application No. 1750398 filed 19 Jan. 2017, both of which are incorporated herein by reference.

### BACKGROUND

The invention relates to self-driving vehicles, possibly of the automotive type, and more specifically to the signaling of such vehicles for their identification.

As known to the person skilled in the art, some vehicles, generally of the automotive type, include a device responsible for driving such vehicles without their driver interacting with the steering wheel, hence their designation under the term “self-driving vehicle” (or “autonomous vehicle”).

Some of these self-driving vehicles are capable of driving without any passengers on board, from an initial location where they are parked, to a second location where a person who has requested (a “requesting person”) the self-driving vehicle is located, for example by means of a phone call or according to a schedule. Such driving operations may, for example, be intended to deliver a parcel to the requesting person, or to pick up the requesting person to transport the requesting person without the requesting person driving to a third location chosen by the requesting person (taxi mode), or to make the vehicle available to the requesting person the second location for the requesting person to use the vehicle freely for manual or autonomous driving.

Where traffic is relatively dense in the area surrounding the second location and if the self-driving vehicle does not have particular characteristics to easily distinguish it from others, it may be difficult for the person making the request to locate the self-driving vehicle when it reaches the vicinity of the requesting person, even in cases where this vehicle belongs to the requesting person. For this reason, a few moments may pass between the time when the vehicle reaches the second location and the moment when the requesting person realizes that the vehicle is intended for them. However, if the vehicle waits for the requesting person in a traffic lane, it may obstruct the movement of other vehicles and thus cause a traffic jam, or even lead to an accident.

It has been proposed to transmit the current position of the requested vehicle to mobile communication equipment carried by the requesting person, throughout its journey to the second location. This allows this requesting person to track changes in its current position in real time on a map displayed on the screen of their mobile communication equipment. However, in dense traffic, information on the current position of the requested vehicle on the map does not fully facilitate its effective identification in its traffic lane. In addition, this solution requires the requesting person to monitor their screen almost continuously, which makes it difficult to simultaneously observe the traffic lane.

### BRIEF SUMMARY

The purpose of the invention is in particular to improve this situation.

For this purpose, a signaling device is proposed for a self-driving vehicle, the self-driving vehicle comprising positioning means capable of determining its current position, lighting means capable of generating light signals and/or external alerting means capable of generating sounds.

This signaling device is characterized by the fact that it includes processing means which are capable, when the vehicle is to meet a person at a location with a known position, of triggering a preset signaling of the vehicle by way of the lighting means and/or the external alerting means as soon as a difference between the current position of the vehicle and the known position of the location is less than a threshold.

This signaling of the autonomous (self-driving) vehicle, when it reaches the vicinity of the person who requested it, may enable this person to more easily identify it, and therefore the time period during which it is parked may be significantly reduced.

The signaling device may comprise other features that may be included separately or in combination, and in particular:
the threshold may, for example, be between 2 meters and 50 meters;
in a first embodiment, when the vehicle also comprises communication means capable of communicating by radio waves with remote communication equipment and acquisition means capable of acquiring data representative of the environment located at least in front of it, the processing means may be capable, when the vehicle is moving towards a location having a known position, of generating images from the data acquired that are representative of at least this environment, and triggering the transmission of these generated images to communication equipment belonging to the person in order to display the images on the screen of this communication equipment;
   the processing means may be capable of attaching a representation of at least part of the vehicle to the images;
in a second embodiment, when the vehicle also comprises communication means capable of communicating by radio waves with remote communication equipment, the processing means may be capable, when the vehicle is moving towards the location position, of triggering the transmission of the current position of the vehicle to communication equipment belonging to the person in order to display an image of an area surrounding this location and a depiction of the transmitted current position on a screen of this communication equipment;
the processing means may be capable of determining a time of arrival at the known position, and of triggering the transmission of this time to the communication equipment belonging to the person in order to display the time on the screen of this communication equipment;
the processing means may be capable of triggering a preset light signaling of the vehicle using the lighting means selected from at least a sequence of a predetermined number of headlamp signals, activation of hazard lights, activation of turn signals on a side of the vehicle facing the location, continuous activation of interior lights, and intermittent activation of interior lights;
the processing means may be capable of triggering a preset sound signaling of the vehicle using the external alerting means selected from at least one sequence of a preset number of horn blasts, a preset tune, and a preset identifier.

A self-driving vehicle, possibly of the automotive type, is also proposed and which comprises positioning means capable of determining the vehicle's current position and lighting means capable of generating light signals and/or external alerting means capable of generating sounds, and a signaling device of the type described above.

### BRIEF DESCRIPTION OF THE FIGURE

Other features and advantages of the invention will become clear by examining the detailed description below, and the accompanying drawing, in which the sole FIGURE schematically and functionally illustrates two road lanes in which vehicles travel, one of the vehicles having been requested by a person and which includes an exemplary embodiment of a signaling device.

### DETAILED DESCRIPTION

The purpose of the invention is to propose a signaling device DS intended to equip a self-driving vehicle VA in order to facilitate identification of the self-driving vehicle by a person PA who has requested it.

Here, the term “self-driving vehicle” is understood to mean a vehicle comprising a control device DC responsible for driving the vehicle without a passenger interacting with the vehicle's steering wheel, and possibly capable of being deactivated (at least partially) in order to allow a driver to drive during a manual driving phase.

In the following and by way of a non-limiting example, the self-driving vehicle VA is considered to be of the automotive type. This may be a car, for example. However, the invention is not limited to this type of vehicle. In fact, it concerns any type of self-driving vehicle, and therefore it concerns, in addition to land vehicles, maritime (or river) vehicles, such as river taxis, and aircraft.

Schematically and functionally represented in the sole FIGURE is a road including two traffic lanes VC1 and VC2 in which three vehicles V1, V2 and VA are traveling. For example, this road is a two-way street in a city.

In the first lane VC1, a self-driving vehicle VA, equipped with a signaling device DS, and a vehicle V1 (which may be self-driving and include a signaling device DS), are traveling.

In the second lane VC2, here traveling in a direction opposite to that of the first lane VC1, a vehicle V2 (which may be self-driving and include a signaling device DS), is traveling.

It is important to note that for the signaling device to be implemented, it is necessary, as illustrated, that the self-driving vehicle VA comprise at least positioning means ML capable of determining its current position pv, and lighting means MEj capable of generating light signals and/or external alerting means MAE capable of generating sounds outside the passenger compartment H.

For example, the positioning means ML may be part of an assisted navigation device.

The lighting means MEj can provide external or internal lighting. Here, the expression “lighting means providing external lighting” is intended to mean a front headlamp unit providing at least one photometric signaling function, for example a high-beam function, or a low-beam function, or a fog light function, or a position light function (or sidelights), or a daytime light function (or DRL (“Daytime Running Light (or Lamp)”—light signaling automatically activated when the vehicle is put into operation during the day)), or a change of direction indication function (or turn signal) and warning lights (or “hazard lights”). Furthermore, “lighting means providing internal lighting” means a lighting device providing lighting inside the passenger compartment H of the self-driving vehicle VA. In the exemplary embodiment shown in a non-limiting manner in the sole FIGURE, the self-driving vehicle VA includes not only primary lighting means ME1 (j=1) providing external lighting, but also secondary lighting means ME2 (j=2) providing internal lighting of its passenger compartment H.

The external alerting means MAE may, for example, constitute a horn. However, in a variant it could include a sound synthesizer capable of generating simple or complex sounds, possibly defining tunes or words or phrases or alphanumeric identifiers.

As illustrated in the FIGURE, a signaling device DS includes at least processing (or computation) means MT.

It should be noted that in the exemplary embodiment illustrated in a non-limiting manner in the FIGURE, the signaling device DS is part of a computer C1, possibly performing at least one other function within the self-driving vehicle VA, and preferably connected to the communication network of the self-driving vehicle VA (possibly of the multiplexed type and allowing the exchange of information between on-board electronic equipment). However, this is not obligatory. Indeed, the signaling device DS could constitute electronic equipment comprising a computer and connected to the communication network of the self-driving vehicle VA, where it exists. Therefore, the signaling device DS may be in the form of software modules or a combination of electronic circuits or components (or “hardware”) and software modules.

The signaling device DS is used whenever the self-driving vehicle VA is required to meet a person PA in a location EC having a known position pc. It should be noted that the signaling device DS may be informed of the known position pc to which the self-driving vehicle VA must travel, either because the latter has received a request from communication equipment used by the person PA or from a service server previously called by the person PA, or because of a schedule previously provided by the person PA or by a third party, for example.

It is important to note that the self-driving vehicle VA may, for example, belong to the person PA or to one of their acquaintances, or belong to a service company (taxi or vehicle rental or parcel delivery). The self-driving vehicle VA may carry several people, possibly as part of a shared service (carpool type). Therefore, the self-driving vehicle VA may be requested at the location EC to pick up at least the person PA making the request for the requesting person to be transported without the requesting person driving to a third location of their choice, or to be made available to the requesting person PA for them to use it freely in manual or self-driving mode, or to deliver a package to the requesting person PA.

The processing means MT are capable, when the self-driving vehicle VA is to meet a requesting person PA at a location EC having a known position pc, of triggering a preset signaling of the self-driving vehicle VA using the lighting means MEj and/or the external alerting means MAE as soon as a difference dp between the current position pv of the self-driving vehicle VA and the known position pc of the location EC is less than a threshold sp. The relationship is thus dp=pc−pv.

The use of the last expression “and/or” here means that as soon as dp is less than sp, the processing means MT trigger either a preset light signaling of the self-driving vehicle VA by the lighting means MEj (ME1 and/or ME2), or a preset sound signaling of the self-driving vehicle VA by the external alerting means MAE, or else both a preset light signaling of the self-driving vehicle VA by the lighting means MEj (ME1 and/or ME2) and a preset sound signaling of the self-driving vehicle VA by external alerting means MAE (which provides redundancy for identification). The alternative that is used depends on the configuration of the DS signaling device. It may be unique (and therefore preset) or selected from at least two of the three alternatives mentioned above, for example, depending on the environmental context of the location EC. It will be understood that the use of high-beam headlamps or the horn (or more generally, sounds) may be regulated in certain areas, such as in cities or near health care facilities (hospitals or clinics). Similarly, the use of certain lighting means MEj (and in particular at least some of the functions of the front headlamp units) may prove to be ineffective in terms of differentiation (or identification) when traffic is heavy.

In addition, “preset signaling” means signaling previously reported to or selected by the requesting person PA (although it may be modified depending on the environmental context, provided that the requesting person PA is informed via their mobile communication equipment (such as a smartphone) or an electronic tablet) that they are carrying, and more generally any connected device with a screen.

The light and/or sound signaling of the self-driving vehicle VA when it reaches the vicinity of the requesting person PA (i.e., dp<sp), may enable the requesting person PA to more easily identify the requested self-driving vehicle VA. Therefore, the period during which the self-driving vehicle VA is parked at the location EC may be significantly reduced, which reduces the probability of causing a traffic jam and the occurrence of an accident.

For example, the threshold sp can be between 2 meters and 50 meters. In this case, the threshold sp may, for example, be equal to 30 meters. It should be noted that the threshold sp can be preset (and therefore fixed) or variable depending on the environmental context of the location EC (and therefore selected by the processing means MT). In addition, the value of the threshold sp may be within value ranges other than those mentioned above (2 m and 50 m).

It should also be noted that a large number of light signals may be used. Thus, light signaling may consist of at least one sequence of a preset number of headlamp signals ME1 (for example equal to three or four, possibly of different durations), or activation of hazard lights ME1, or activation of turn signals ME1 on the side of the self-driving vehicle VA facing the location EC, or continuous activation of interior lights ME2, or intermittent activation of interior lights ME2. The light signaling used depends on the configuration of the signaling device DS. It can be unique (and thus preset) or selected from at least two options, for example depending on the environmental context of the location EC.

It is important to note that instead of using front headlamp units ME1 to perform the preset light signaling, rear light units could be used when the self-driving vehicle VA is forced to stop further on from the location EC because there is no space to stop at the preset location (EC).

In the example shown in a non-limiting manner in the sole FIGURE, the processing means MT trigger headlamp signals using the first lighting means ME1 as soon as dp is less than sp.

It should also be noted that a wide variety of sound signals may be used. Thus, sound signaling may comprise at least a sequence of a preset number of horn blasts (for example two or three, possibly of different durations), or a preset tune, or a preset identifier (possibly that which is displayed on the license plate of the self-driving vehicle VA or any other part of the vehicle (taxi or delivery driver or rental identifier)). The sound signaling used depends on the configuration of the signaling device DS. It can be unique (and thus preset) or selected from at least two options, for example depending on the environmental context of the location EC.

It should also be noted that several options may be offered to the person PA when the self-driving vehicle VA comprises additional technical means.

Thus, the self-driving vehicle VA may, for example, also comprise communication means MC capable of communicating by radio waves with remote communication equipment, and acquisition means MAI capable of acquiring data representative of the environment at least in front of the vehicle. In this case, the processing means MT may, for example, be capable, when the self-driving vehicle VA is moving towards the location EC having a known position pc, of generating images representative of at least this environment from this acquired data. The processing means MT can then trigger the transmission of these generated images to communication equipment belonging to the requesting person PA in order to display the images on a screen of this communication equipment. Thus, when the requesting person PA is familiar with the environment of the location EC where they are waiting, they can easily recognize on the screen of their communication equipment where the self-driving vehicle VA is located at the moment in question, which further facilitates its identification using its preset signaling.

The communication means MC can exchange messages using radio waves with communication equipment either directly, for example and in a non-limiting manner, using the wireless communication standard Bluetooth or Wi-Fi or WIMAX or 5G, or indirectly via a network of wireless communication devices, for example of the terrestrial type (possibly 3G or 4G) and/or satellite type.

The communication equipment is preferably of the mobile type and carried by the requesting person PA. As indicated above, it may, for example, be a smartphone or an electronic tablet.

The acquisition means MAI is responsible for analyzing at least part of the environment of the self-driving vehicle VA located in front of the vehicle (VA). For this purpose, it may, for example, include ultrasonic sensors and/or at least one camera and/or at least one scanning laser and/or at least one radar or lidar. It will be understood that the data acquired may define real images from the environment, or be used to generate computer-generated images or environmental maps.

For example, the processing means MT may also be capable of attaching to the images, transmitted to the communication equipment of passenger PA, a representation of at least part of the self-driving vehicle VA. This further facilitates the identification of the vehicle (VA) by its predefined signaling.

When the self-driving vehicle VA only comprises communication means MC, the processing means MT may be capable, when the vehicle VA is moving towards the location EC having a known position pc, of triggering the transmission of the current position pv of the self-driving vehicle to communication equipment belonging to the requesting person PA in order to display an image of an area surrounding the location EC and a depiction of the transmitted current position pv on a screen of this communication equipment. The image of this area may, for example, be a map or a plan (possibly of a city) or a satellite photograph. Thus, the requesting person PA can easily track changes in the position pv of the self-driving vehicle VA on the screen of their communication equipment, which facilitates the identification of the vehicle using its preset signaling.

It should also be noted that the processing means MT may also be capable of determining an arrival time at the known position pc of the location EC, and of triggering the transmission of this time to the communication equipment belonging to the requesting person PA in order to display the time on the screen of this communication equipment. For example, the processing means MT may determine this arrival time using an assisted navigation device that the self-driving vehicle VA may be equipped with.

It should also be noted that the processing means MT may be capable of triggering internal lighting and/or heating/cooling of the passenger compartment H of the self-driving vehicle VA shortly before reaching the known position pc of the location EC, to accommodate the person PA in optimal conditions.

1. A signaling device for a self-driving vehicle, the self-driving vehicle comprising positioning means capable of determining a current position of the vehicle, lighting means capable of generating light signals and/or external alerting means capable of generating sounds, said signaling device including processing means which are capable, when said vehicle is to meet a person at a location having a known position, of triggering a preset signaling of said self-driving vehicle by said lighting means and/or said external alerting means as soon as a difference between said current position of the vehicle and said known position of the location is less than a threshold, wherein, in the presence of a vehicle also comprising communication means capable of communicating by radio waves with remote communication equipment, and means of acquisition capable of acquiring data representative of the environment located at least in front of said self-driving vehicle, said processing means is capable, when said vehicle is moving towards said location having a known position, of generating images representative of at least said environment from said acquired data, and of triggering the transmission of said generated images to communication equipment belonging to said person in order to display said images on a screen of the person's communication equipment.

2. A signaling device for a self-driving vehicle comprising positioning means capable of determining a current position of the self-driving vehicle, lighting means capable of generating light signals and/or external alerting means capable of generating sounds, said signaling device including processing means capable, when said vehicle is to meet a person at a location having a known position, of triggering a preset signaling of said vehicle by said lighting means and/or said external alerting means as soon as a difference between said current position of the vehicle and said known position of the location is less than a threshold, characterized in that in the presence of a vehicle also comprising communication means capable of communicating by radio waves with remote communication equipment, said processing means is capable, when said vehicle is moving towards said location having a known position, of triggering the transmission of said current position of the vehicle to communication equipment belonging to said person in order to display an image of an area surrounding said location and a depiction of said transmitted current position on a screen of the person's communication equipment.

3. The signaling device according to claim 2, wherein said processing means is capable of attaching to said images a depiction of at least a part of said vehicle.

4. The signaling device according to claim 2, wherein said processing means is capable of determining a time of arrival at said known position of the location, and triggering the transmission of said time to said communication equipment belonging to said person in order to display said time on said screen of the person's communication equipment.

5. The signaling device according to claim 2, wherein said processing means is capable of triggering a preset light signaling of said vehicle using said lighting means selected from a set including at least a sequence of a preset number of headlamp signals, activation of hazard lights, activation of turn signals on a side of said vehicle facing said location, continuous activation of interior lights, and the intermittent activation of interior lights.

6. The signaling device according to claim 2, wherein said processing means is capable of triggering a preset sound signaling of said vehicle by said external alerting means selected from a set including at least a sequence of a preset number of horn blasts, a preset tune, and a preset identifier.

7. The signaling device according to claim 2, wherein said threshold is between 2 meters and 50 meters.

8. A self-driving vehicle comprising positioning means capable of determining a current position of the vehicle, and lighting means capable of generating light signals and/or external alerting means capable of generating sounds, wherein said vehicle further includes a signaling device according to claim 2.

9. The self-driving vehicle according to claim 8, wherein said vehicle is of the automotive type.
